(19) United States
(12) Patent Application Publication
(10) Pub. No.: US 2014/0077610 A1
(43) Pub. Date: Mar. 20, 2014

(54) SELECTING A HYBRID POWER SOURCE

(71) Applicants: Yanchai Zhang, Dunlap, IL (US); Evan Earl Jacobson, Edwards, IL (US)

(72) Inventors: Yanchai Zhang, Dunlap, IL (US); Evan Earl Jacobson, Edwards, IL (US)

(73) Assignee: CATERPILLAR, INC., Peoria, IL (US)

(21) Appl. No.: 13/617,574

(22) Filed: Sep. 14, 2012

(51) Int. Cl. H02J 4/00

(52) U.S. Cl. 307/80

(57) ABSTRACT

A method of controlling power in a hybrid power system comprising a plurality of power sources is also disclosed. The state of charge of each power source may be determined where the power source stores and provides power. A current power score for each power source may be determined where the power score is a function of the current state of charge and state of efficiency. If there is power demand, power may be provided from the power source with the highest current power score.

Large equipment has to be able to complete a variety of tasks. The equipment has to be able to execute tasks that require great strength and power while being mobile. A variety of systems are including to execute these tasks, including a primary power source and other systems which may redeploy power from the primary power source, such as hydraulic systems and electrical systems.

Providing additional power to move bigger objects and lift bigger things usually means installing a larger engine with additional power. Additional power has often meant more fuel consumption. While engine efficiency has improved over time, fuel costs are still significant. Every gain in efficiency is meaningful. In addition, the equipment has to be reliable and long lasting, meaning that the pursuit of efficiency cannot overshadow the need for the equipment to be long lasting.

### SUMMARY

A power platform for a motorized work device that includes hybrid power sources is disclosed. The hybrid power system may include a hydraulic power source that provides power and stores power, an electric power source that provides power and stores power and a kinetic power source that provides power and stores power. The power platform may also include an engine, such as an internal combustion engine, including a reduced power than engines for similar sized devices where the hydraulic power source, electric power source and kinetic power source provide additional power to the engine when required. The hydraulic power source, the electric power source and kinetic power source may also store power when excess power is available to be stored. Further, if the engine is under stress, additional power may be provided from at least one of the hydraulic power source, the electric power source and the kinetic power source.

The kinetic power source may include a high speed, low mass flywheel that is in communication with the power source. The hydraulic power source may include an accumulator that is filled if reverse pressure is presented to the hydraulic system along with a hydraulic pump and hydraulic supply lines that communicate with the hydraulic pump, the accumulator and the hydraulic supply lines. The electric power source may include an electricity storing device such as one or more batteries or capacitors that store electricity when reverse power is provided to a generating device along with an integrated starter-generator which is in communication with the drivetrain of the device and provides power as a motor when needed.

The system may operating in a variety of modes depending on a variety of factors including the location of the device, the current demands on the device, the start of charge of the hybrid systems and available power from the primary power unit. The decision on the mode to use may be made using a remote or distant computing device physically configured to make the decision. Further, the decision on which hybrid system to use store or provide additional power may be based on a plurality of functions that may vary based on a variety of inputs to the system.

A method of controlling power in a hybrid power system comprising a plurality of power sources is also disclosed. The state of charge of each power source may be determined where the power source stores and provides power. A current power score for each power source may be determined where the power score is a function of the current state of charge and state of efficiency. If there is power demand, power may be provided from the power source with the highest current power score. If the power demand is beyond the capabilities of the power source with the highest current power score, additional power may be provided from the power source with the next greater power score. If there is excess power, the method may determine if any of the powers sources has excess capacity and if the power sources have excess capacity, power may be added to the power source that has the lowest power score. In some situations, the current power source may be used until the current power source falls below a minimum power level. Of course, additional embodiments of the system are possible and are contemplated.

### BRIEF DESCRIPTION OF THE DRAWINGS

FIG. 1 is an illustration of a device with hybrid power equipment;

FIG. 2 is an illustration of blocks of parts that may up a hybrid power system;

FIG. 3 is an illustration of an integrated starter/generator power system;

FIG. 4 is an illustration of a hydraulic power and storage system;

FIG. 5 is an illustration of kinetic storage devices;

FIG. 6 is an illustration of blocks in a method of selecting a mode;

FIG. 7 is an illustration of the elements of the hybrid power system in regeneration mode;

FIG. 8 is an illustration of the elements of the hybrid power system in generation mode;

FIG. 9 is an illustration of the elements of the hybrid power system in assist mode;

FIG. 10 is an illustration of the elements of the hybrid power system in creep mode;

FIG. 11 is an illustration of the elements of the hybrid power system in braking mode;

FIG. 12 is an illustration of the elements of the hybrid power system in starting mode;

FIG. 13 is an illustration of the decision on which hybrid system to use;

FIG. 14 is an illustration of another manner of making the decision on which hybrid mode and which hybrid system to use;

FIG. 15 is an illustration of a portable computing device communicating to a remote computing device;

FIG. 16 is an illustration of the elements of a portable computing system;

FIG. 17 is an illustration of the elements of server based computing system;

FIG. 18 is an illustration of a possible display of the status of the various hybrid systems; and

FIG. 19 is an illustration of the inputs that are used to decide on the mode to be used and the hybrid system to be used.

### DESCRIPTION

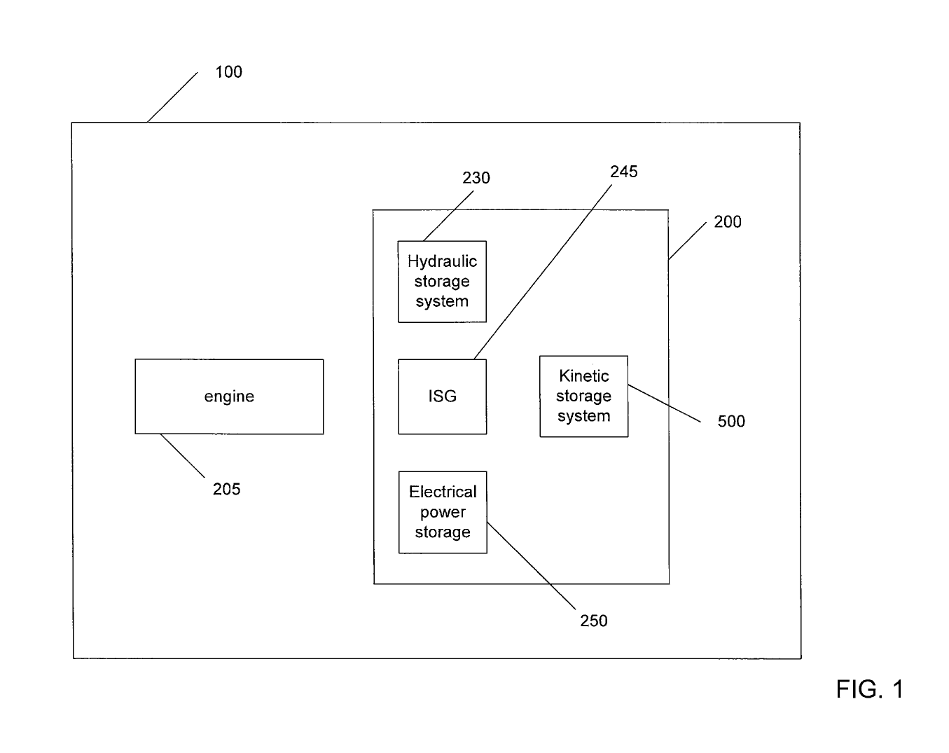

FIG. 1 illustrates one embodiment of a power platform for a motorized work device. The work device may be a variety of devices. Some example work devices may include, but should not be limited to, bulldozers, diggers, earth movers, graders, etc. In general, the work devices have an internal combustion based power source, such as an engine that operate on diesel fuel or gasoline or any other appropriate fuel. Other systems could operate using the power from the power source such as hydraulic systems but the other systems did not store or contribute power back to the power source. In the past, the internal combustion engine had to be sized such that it could provide sufficient power alone to operate the vehicle as it did not have any other power supplying systems to rely upon.

There are a variety of hybrid power source that may assist a main power source, each of which has its own advantages and disadvantages. FIG. 1 may illustrate a variety of hybrid power sources that may be part of a work device 100. At a high level, the hybrid power sources 200 may store power when excess power is available, such as when a device 100 is traveling downhill, and may supply power when excess power is needed such as lifting a heavy object. At times, the hybrid sources may be the primary source of power. At other times, the hybrid sources 200 may not supply any power to the main source of power. At yet other times, one or more of the hybrid power sources 200 may assist the main power source 205 when excess power is needed. The decision of which hybrid source 200 to use and when may be governed by an algorithm. The result of the hybrid system is that a smaller main power 205 source may be used which may result in a more efficient system.

FIG. 1 is an illustration of a sample work device 100 with hybrid power sources 200. In one embodiment, an internal combustion engine 205 may be the main source of power and may be used along with the hybrid power sources 200. In other embodiments, any of the hybrid sources 200 of power may be the main power source 205 with the other hybrid power sources 200 supplying power on an as needed basis. The main power source 205 may be smaller than a single main power source 205 as the hybrid sources 200 may provide additional power when needed such that the main power source 205 may be smaller, lighter and more efficient than in a device without the hybrid power sources 200.

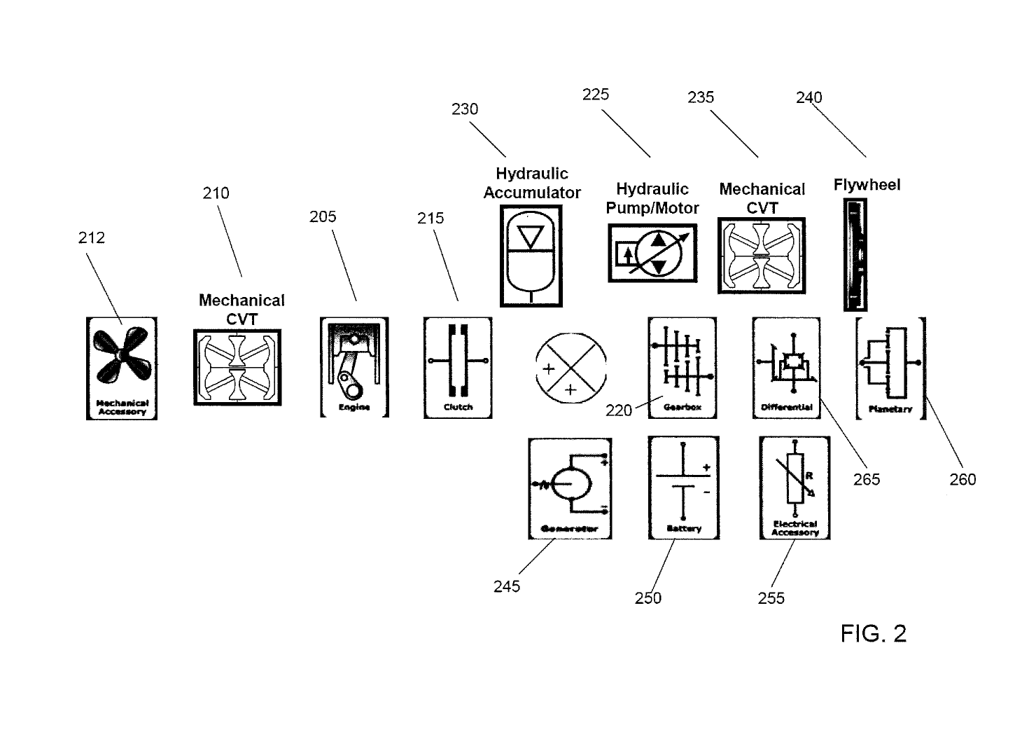

Referring to FIG. 2, possible sources of hybrid power 200 and storage may include a kinetic device 500, such as a flywheel 240, a hydraulic device 230 such as a large hydraulic accumulator in communication with a hydraulic pump/motor 225 and an integrated starter/generator 245 that may be connected to various electricity storage devices 250 such as batteries or capacitors. Of course, some of the hybrid sources 200 may be omitted and others added. The disclosed combinations and arrangements are not meant to be limiting but only example as there are a variety of ways to uses hybrid power systems 200 with a main power system and all of these various arrangements are possible and contemplated.

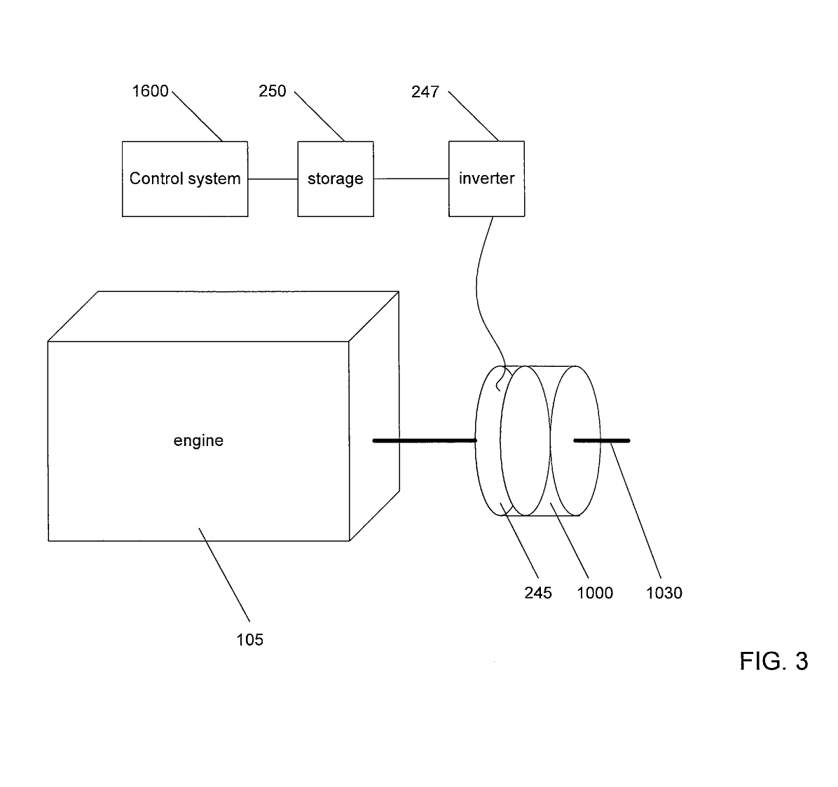

FIG. 3 may illustrate some of the elements of an electrical hybrid system. An integrated starter/generator 245 may be used before or after a transmission to act as an electric generator when excess power is available such as when a device 100 is proceeding downhill or when brakes are being applied. An integrated starter generator 245 may be an electric motor that provides torque to a shaft when electricity is applied to it and provides electricity when the shaft is spun using excess force from the device 100. The generated electricity may be stored in a variety of way, such as in batteries 250 or in capacitors. In addition, in some embodiments, the integrated starter generator 245 may serve to eliminate the need for an impeller clutch.

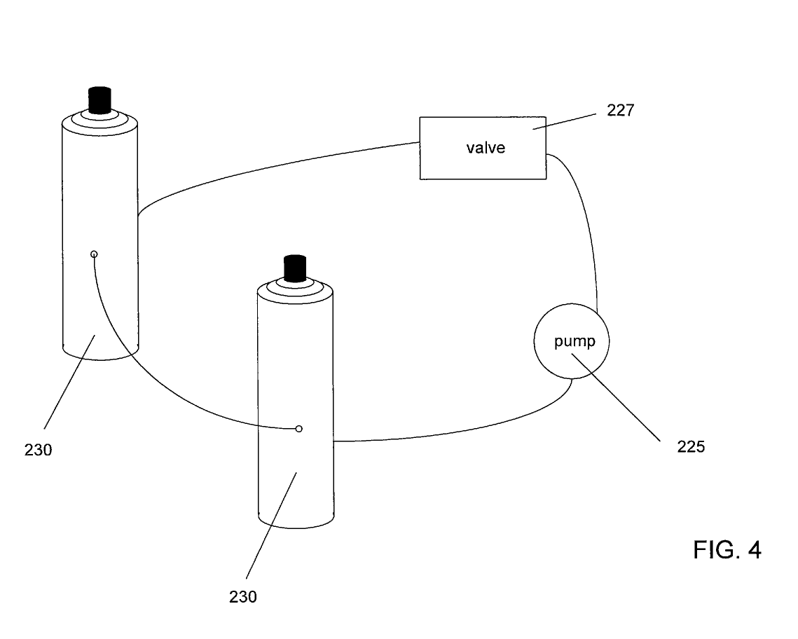

Another form of power may be a hydraulic source. FIG. 4. may illustrate one embodiment of a hydraulic power source. The hydraulic power source may include a hydraulic pump/motor 225, a valve 227 to direct the fluid and one or more accumulators 230 that store hydraulic fluid under pressure. The hydraulic pump/motor 225 may be driven by the force of the device as is travels downhill, for example, and the pump/motor 225 may force hydraulic fluid into the accumulator 230 where it may rest under pressure until it is needed at which time the pressurized fluid may leave the accumulator 230 and provide power to a hydraulic device. The accumulator 230 may be any type of accumulator 230 that is appropriate for the device. In some embodiments, a larger accumulator 230 such that the accumulator 230 may store more power in the form of hydraulic fluid that is under pressure.

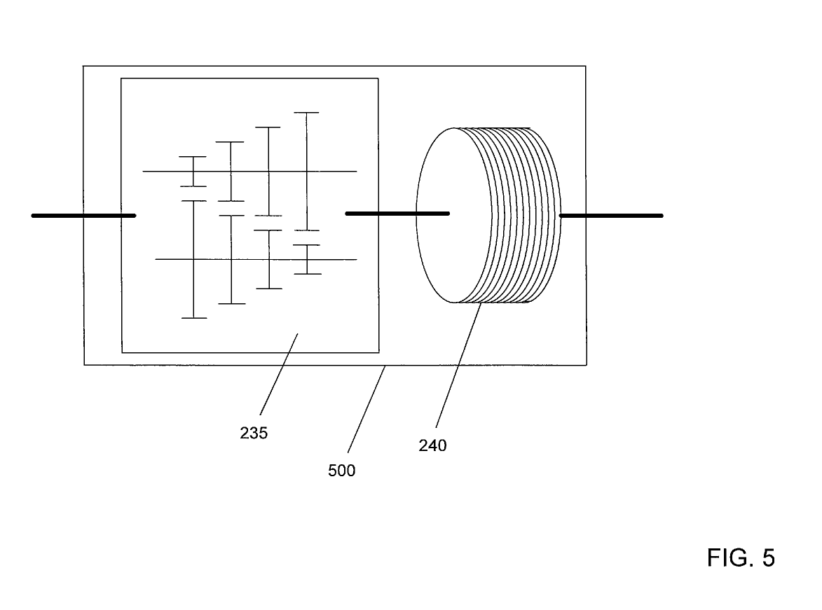

Another hybrid power source 200 may be a kinetic power storage device 500. FIG. 5 may illustrate a sample kinetic power source 500. A kinetic storage device 500 may store energy in a spinning object 240 such as a flywheel. In some embodiments, the spinning object 240 is a heavy object that once it is spinning is hard to stop as the momentum of the object 240 wants to keep the object spinning. Spinning a heavy object 240 at a high speed may be difficult and controlling heavy objects 240 that spin at high speeds may be a challenge. In other embodiments, the spinning object 240 may be lighter but may spin at a high rate of speed which also creates a significant amount of momentum that wants to keep the object 240 spinning. In this way, the extra weight from the spinning object 240 may be less, but energy still may be stored. FIG. 5 may illustrate a sample kinetic storage device 500 which may have a flywheel 240 and a transmission 235.

Energy may also be supplied from the kinetic storage device 500 but using the kinetic energy stored in the spinning object 240 to supplement the main power source 205 or any other source 200. For example, a flywheel 240 may be the kinetic storage object and may be in communication with the crankshaft of an internal combustion engine 205 or the drivetrain to provide additional power to the main power source 205. Of course, the kinetic storage object 240 may provide power to an integrated starter/generator 245, for example, which may provide power to the other hybrid power sources 200 which may be stored by the other objects.

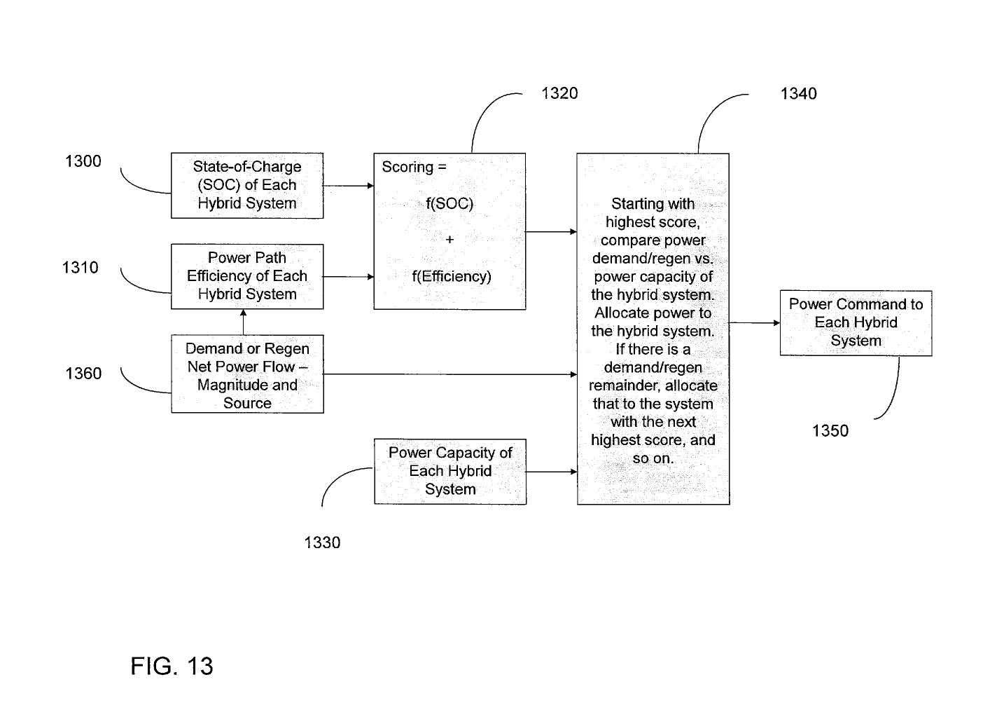

At a high level, the hybrid power devices 200 store power when excess power is available and provide power when additional power is needed. The decision on which hybrid power source is used to provide additional power and which power source is used to store power at which time may be based on a variety of factors which will be discussed further in this application in reference to FIG. 13. In addition, more than one hybrid device 200 may be used to store power or to provide power at a time.

Referring again to FIG. 2, some of the components of the hybrid power system 200 may be illustrated. The main power source may be an engine 205. The power from the engine 205 may pass through an engine crankshaft to a mechanical transmission such as a continuously variable transmission or a clutched gearbox to power mechanical accessories 212.

The power may also pass through a clutch 215. The clutch 215 may be engaged during most operations. The clutch 215 may be opened or disengaged when the machine 100 is at idle. The clutch 215 may also be open during engine off events. In such a situation, the engine 205 may be started without the burden of powering the hybrid systems 200 or other downstream loads. In addition, the hybrid systems 200 may be used to power the device 100 such as in creep mode when the main engine 205 is off.

The clutch 215 may also be in communication with a gear box 220 which may amplify or reduce the rotational motion and or power passing through the hybrid sources 200 and the main power source 205. From the gearbox 220, power may be in communication with a hydraulic pump/motor 225. In times of excess power, the hydraulic pump/motor 225 may operate to fill the hydraulic accumulator 230 with fluid under pressure. In times of power need, the force stored in the accumulator 230 may be released to provide force to the hydraulic pump/motor 225 which may communicate the power to the gearbox, 220, the clutch 215 and then the main power source 205.

The gearbox 220 may also be in communication with an additional mechanical continuously variable transmission 235 which may be in communication with a kinetic storage object 240 such as a flywheel. In times of excess power, the mechanical continuously variable transmission 235 may communicate power to the kinetic storage device 500 which may spin an object 240, thereby storing the energy. In times of power need, the kinetic energy stored in the kinetic storage object 240 may be release to the mechanical continuously variable transmission 235 which may communicate to the gearbox 220 and then to the main power source 205.

The gearbox 220 may also be in communication with an integrated starter/generator 245. The integrated starter/generator 245 may operate as a starter and a motor, adding power to the main power unit 205 when needed. The power for the integrated starter/generator 245 may come from an electrical storage device 250 such as a battery or capacitor. In addition, electrical accessories 255 may operate by drawing on the electrical storage device 250. In times when there is excess power, the integrated starter/generator 245 may spin and generate electricity which may be stored in the electronic storage device 250.

Logically, the main power source 205 may be in communication with the gearbox 220 which may provide power to the differential 265 and a planetary gear 260. In some situations, the main power source 205 and the hybrid power sources 200 may provide power to the planetary gears 260 which may then power the device 100. In other situations, the planetary gears 260 may provide excess force to the device 100 such as when the vehicle 100 is traveling downhill. This excess power may be used to provide power to the various hybrid systems 200 to be stored for a later time. Similarly, when the device 100 is braking, the excess force may be used to charge the various hybrid systems 200. In yet another aspect, when the main power source 205 is operating at a desired speed but the device 100 does not require all the power, the excess power may be diverted to the hybrid power sources 200 to be stored for future use.

Hybrid Modes

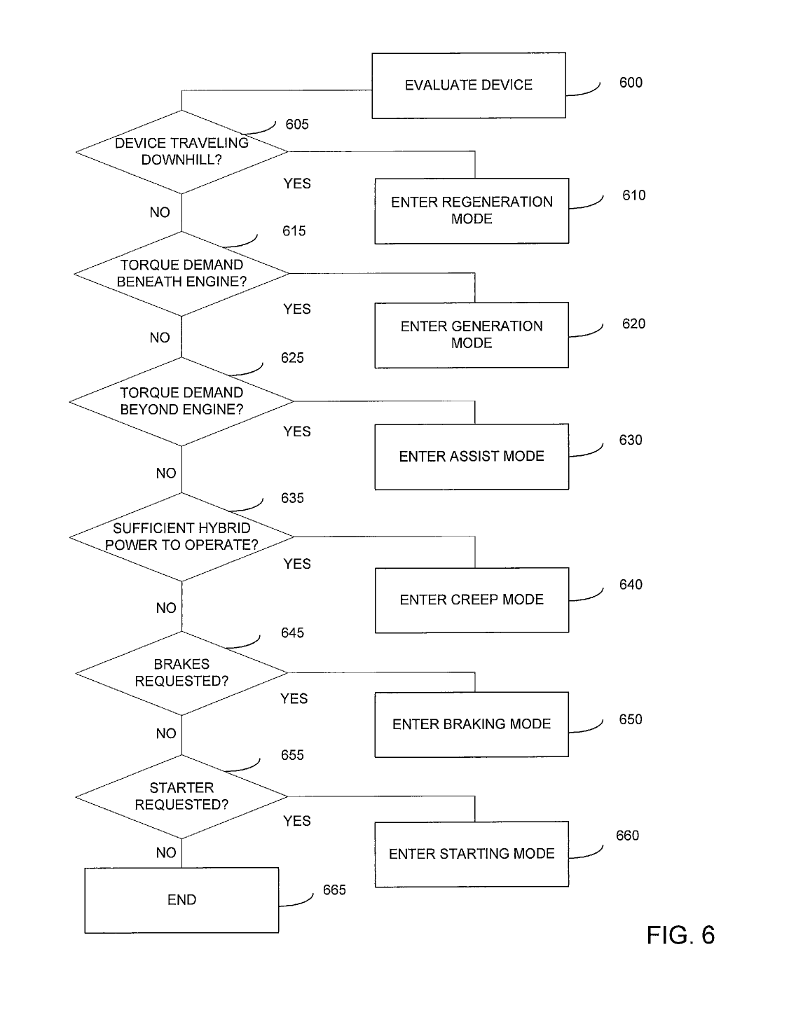

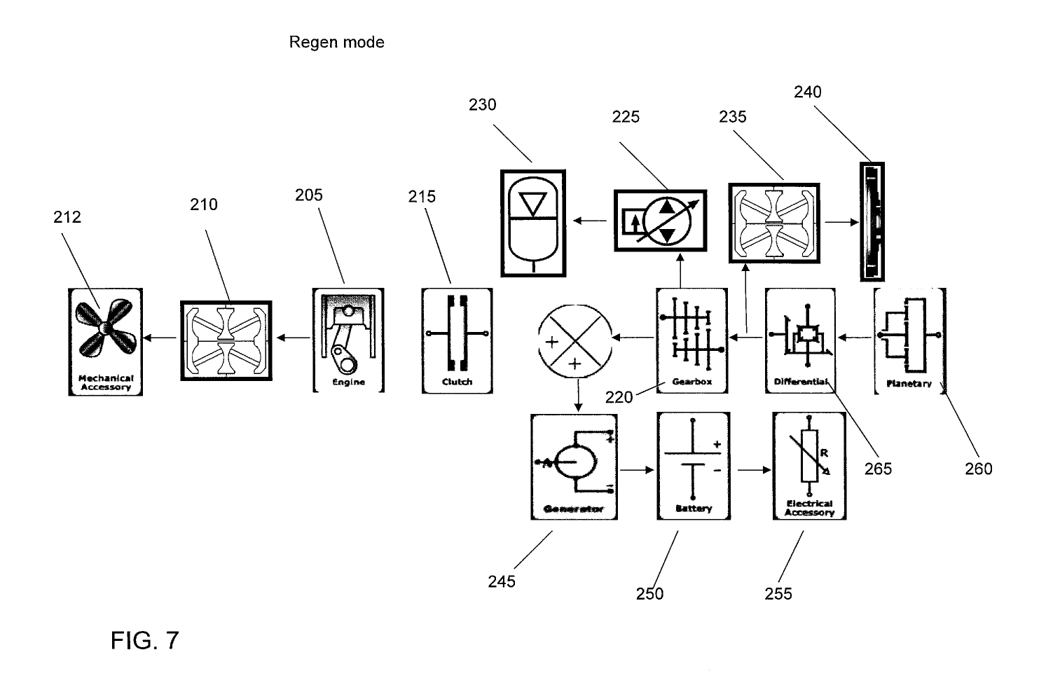

The device 100 may have a variety of modes. The decision on which mode to use may be based on a variety of factors. FIG. 6 may illustrate one manner of selecting an operating mode from a plurality of modes. At a high level, if the device 100 needs more power than is currently available from the main power source 205, the system may operate in assist mode where the hybrid systems may provide additional power to the main power source 205. Similarly, if the device 100 has excess force acting upon it, the device 100 may enter into regeneration mode where the excess power or force may be harnessed and stored for later use. The various modes may occur at the same time or may be separate and may be further described in reference to FIGS. 7-12.

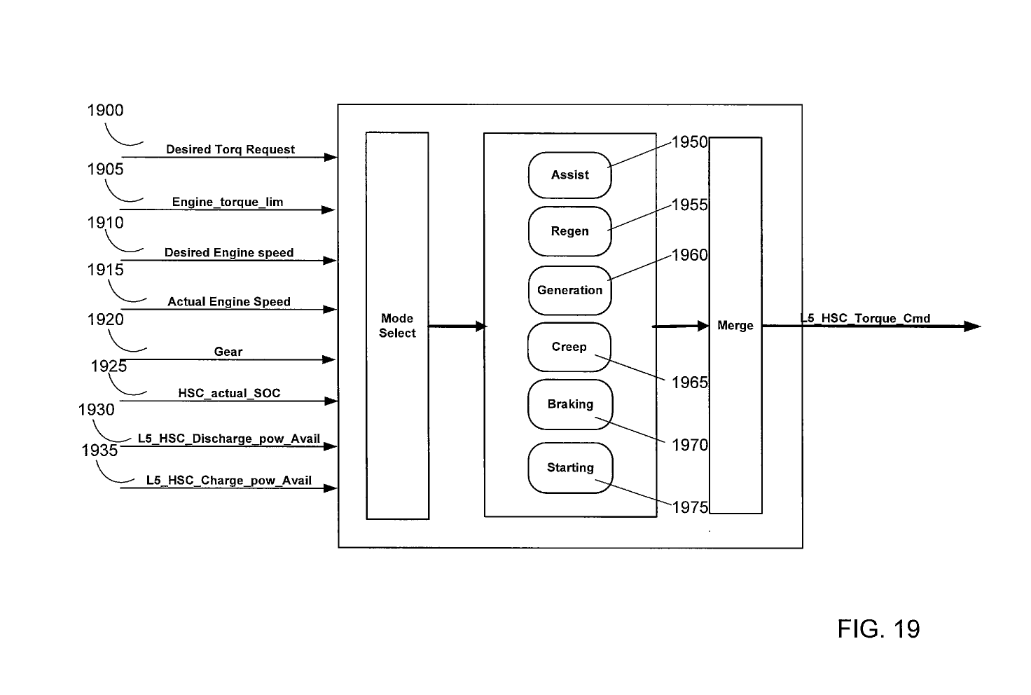

At block 600, the device 100 operating status may be evaluated. In the illustration in FIG. 6, the blocks are shown as being evaluated in a sequence, but the sequence is not mandatory and the blocks may be performed in any order. The evaluation may review operating conditions of the vehicle. Some sample variables that may be evaluated may be illustrated in FIG. 19 and may include but are not limited to a desired torque request 1900, an engine torque limit 1905, a desired engine speed 1910, an actual engine speed 1915, a current gear selection 1920, hybrid system control actual state of charge 1925, the hybrid system control indication of the discharge power currently available 1930 and the hybrid system charge power available 1935.

At block 605, it may be determined whether the device is traveling downhill or in a manner that generates excess force that may be converted into power. If the determination is true, the regeneration mode may begin at block 610. The regeneration mode is described further with reference to FIG. 7 and may convert the excess force into a form of energy that may be stored and later used by the hybrid power systems 200. FIG. 13 may illustrate one method of deciding which manner to store the excess energy. If the determination is false, the method may proceed to block 615.

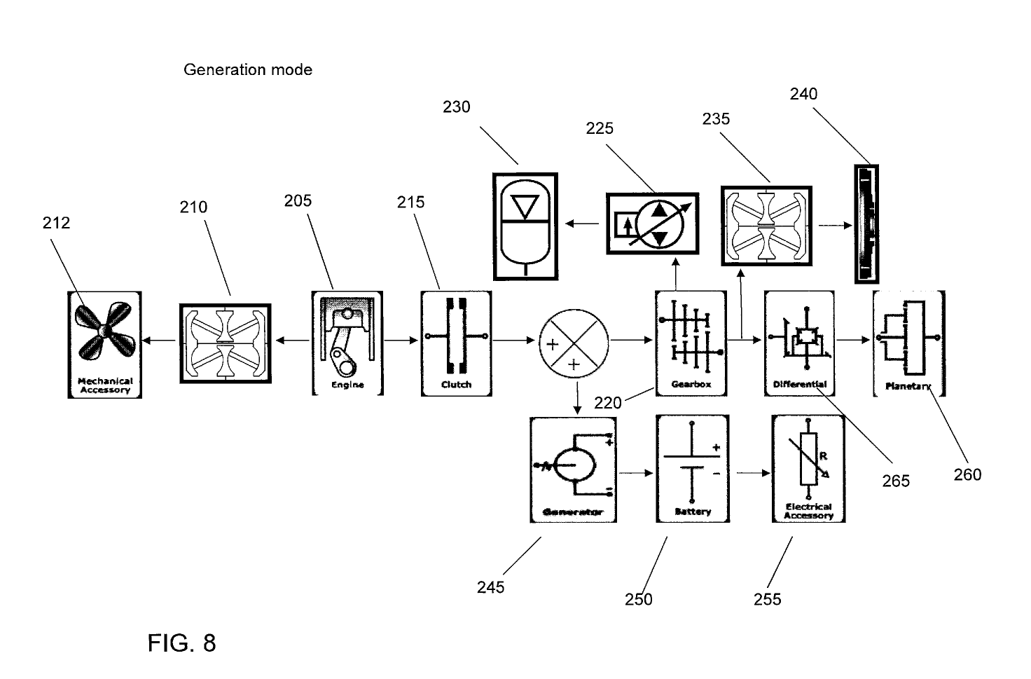

At block 615, it may be determined whether the engine is producing excess power that may be converted into power that may be stored for future use by the hybrid power systems 200. If the power demand from the engine is below its capability, it may be desirable to increase the power production of the engine for the purpose of storing energy via the hybrid systems. For example, the current torque demand on the engine 205 may be low and excess torque may be available at the current engine 205 speed to be used to charge the hybrid power systems 200. If the determination is true, the generation mode may begin at block 620. The generation mode is further described with reference to FIG. 8 and may take excess energy from the engine 205 and convert it into a form of energy that may be stored and later used by the hybrid power systems 200. FIG. 13 may illustrate one method of deciding which manner to store the excess energy. If the determination is true, the generation mode may begin. If the determination is false, the method may proceed to block 625.

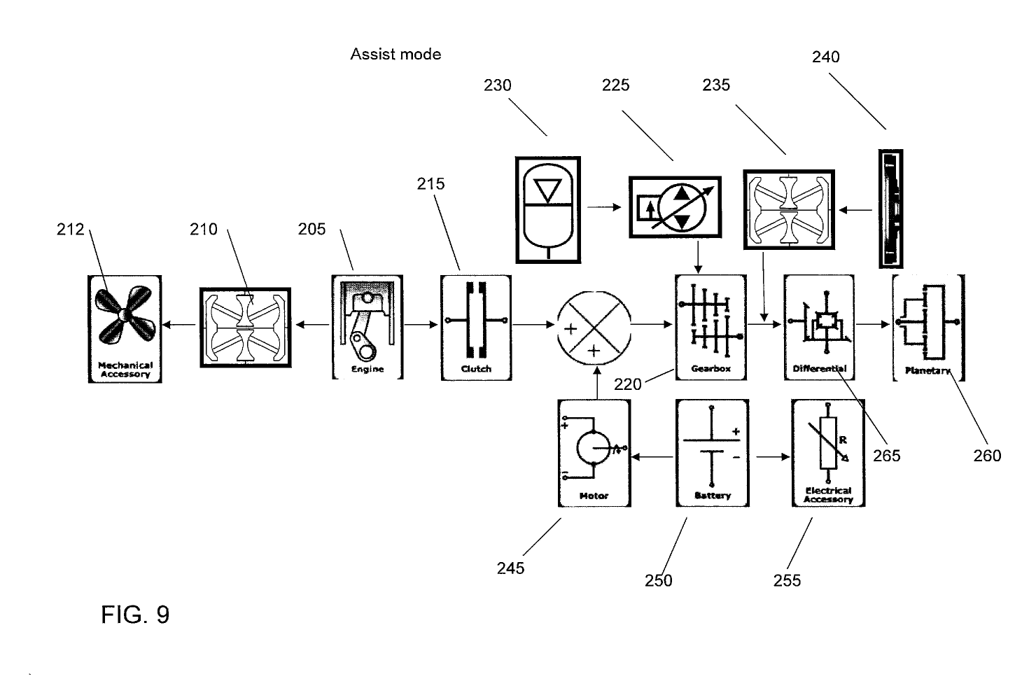

At block 625, it may be determined whether the engine 205 requires additional power. For example, the torque demanded may exceed the torque currently being produced by the engine 205. If the determination is true, at block 630 the assist mode may begin. The assist mode is further described with reference to FIG. 9 and may entail having the hybrid power sources 200 provide additional torque to the engine 205. If the determination is false, the method may proceed to block 635.

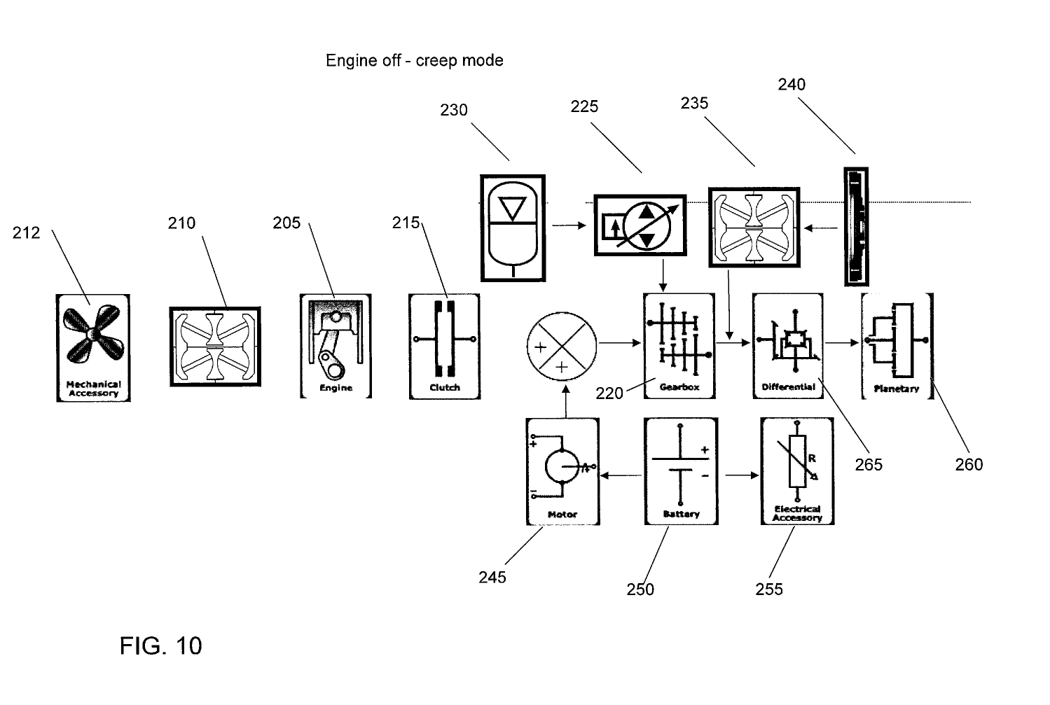

At block 635, it may be determined whether the power required by the device 100 is low enough that the main power source 205 is not required and that the power required may be provided by the hybrid power sources 200. For example, the device 100 may have to slowly creep and the hybrid power sources 200 may be capable of providing the needed power without starting the engine 205 and using fuel. If the determination is true, at block 640, the creep mode may begin. The creep mode is discussed further in reference to FIG. 10. If the determination is false, the method may proceed to block 645.

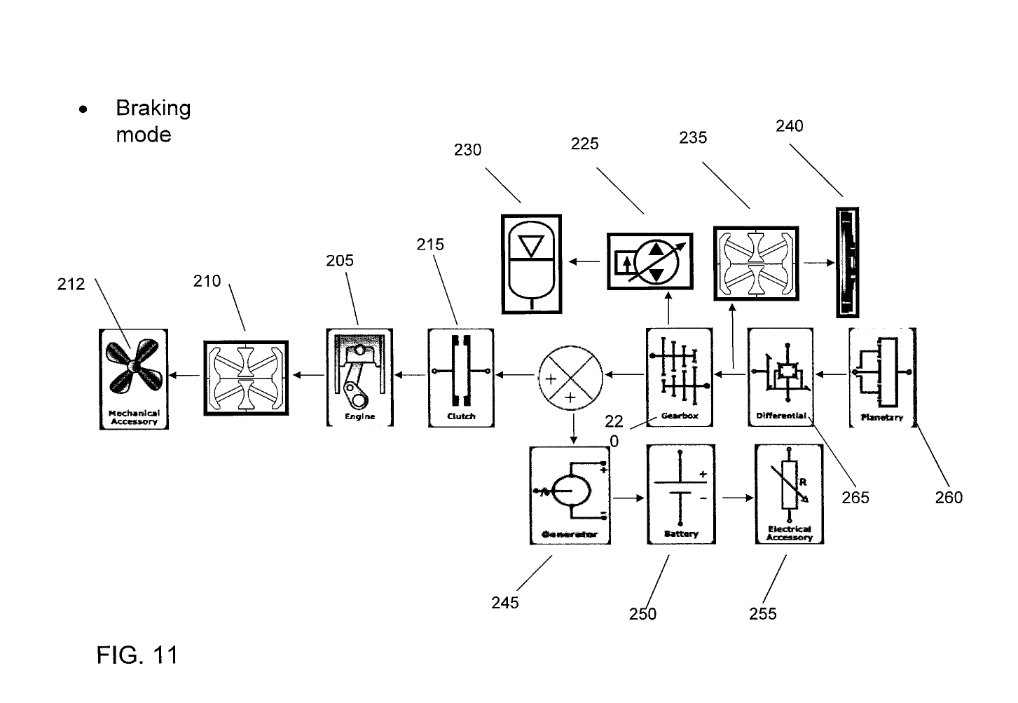

At block 645, it may be determined whether the device is braking. Braking traditionally is accomplished by applying a slowing force, such as clamping onto a rotor. Braking also may be accomplished by converting the slowing force into energy that may be stored. For example, a kinetic storage device 500 may be connected to the wheels that need to be slowed and the force of turning the kinetic storage object 240 may cause the wheels to slow while the energy is stored in the kinetic storage device 500. Similarly, the wheel to be slowed may be in communication with a generator (or an integrated starter/generator 245) which may slow the wheel and generate electricity which may be stored in a storage device 250 like a battery or capacitor. Not surprisingly, the wheel to be slowed may also be in communication with a hydraulic pump/motor which may store hydraulic fluid under pressure in an accumulator 230 and may cause the wheel to slow. If the determination at block 645 is true, at block 650 the braking mode may begin. The braking mode is discussed further in reference to FIG. 11. In the braking mode, power from the decelerating device 100 may be stored in a variety of ways for future use by the hybrid power systems 200. FIG. 13 may illustrate one method of deciding which manner to store the excess energy. If the determination is false, the method may proceed to block 655.

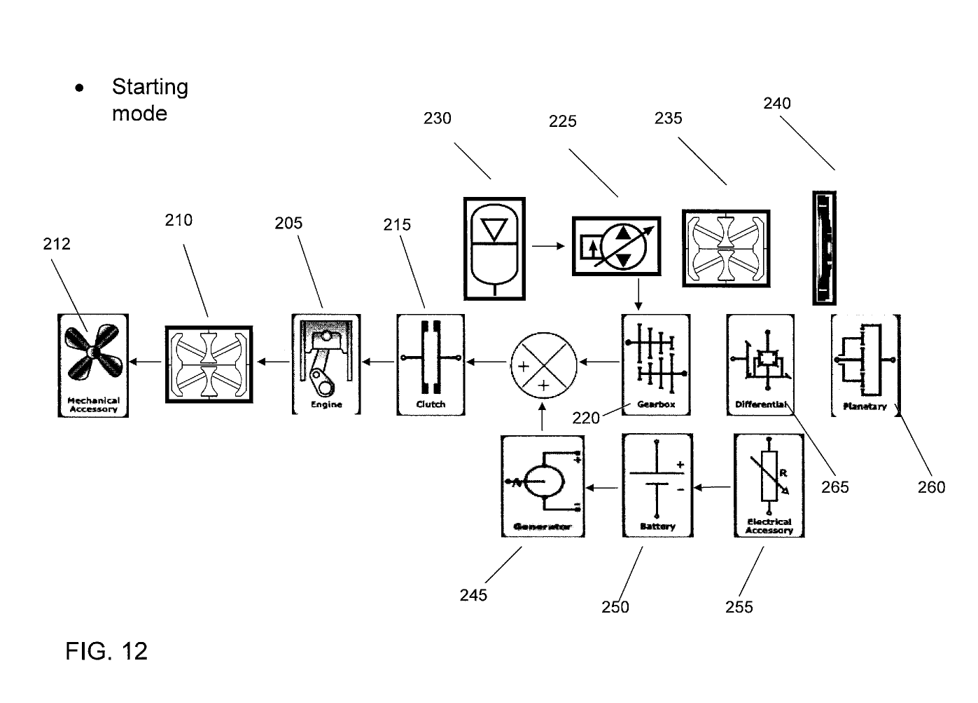

At block 655, it may be determined whether the device 100 has entered starting mode. In starting mode, a starter (or an integrated starter/generator 245) may use power from a battery 250 to spin a motor 245 in communication with the engine 205 such that it will start. In other embodiments, power from an accumulator 230 may be transferred through a hydraulic motor 225 to the gearbox 220 which may be in communication with the engine 205 which may then spin and start. The starting mode is discussed further in reference to FIG. 12. The point of the start mode is to spin the engine 205 and start it. If the determination is true, the starting mode may begin at block 660. If the determination is false, the method may proceed to block 665. At block 665, the method may end or the method may repeat.

Regeneration Mode

FIG. 7 may illustrate a regeneration mode, such as when the device 100 is traveling downhill. The force of gravity may cause there to be excessive force on the device 100. Usually, a braking force of some type would have to be applied to keep the vehicle from picking up excessive speed. The hybrid power sources 200 may be engaged and may be used to absorb the excess energy. In FIG. 7, the excess power is transferred through the planetary gears 260 to the differential 265. From the differential 265, the power may flow to the additional continuously variable transmission 235 which may provide power to the kinetic storage object 240. In addition, power may flow through the differential 265 to the gear box 220 where power may be provided to the hydraulic pump/motor 225 which may pump hydraulic fluid to the hydraulic accumulator 230 which may store the fluid under pressure. The gearbox 220 may also provide power to an integrated starter/generator 245 which may cause the rotor to spin which may generate electricity which may be stored in a storage device 250 such as a battery or capacitor. In addition, the clutch 215 may be disengaged to avoid having power transmitted to the engine 205 at time when the engine does not need additional power.

Generation Mode

FIG. 8 may illustrate yet another mode of operation. In the generation mode, the main power source 205 may generate power. The power from the engine 205 may pass through an engine crankshaft to a mechanical transmission 210 such as a continuously variable transmission to power mechanical accessories 212. The power may also pass through a clutch 215. At time of excess power, the clutch 215 may engage and provide the excess power to the hybrid power devices 200 to be stored for future use.

The clutch 215 may also be in communication with a gear box 220 which may amplify or reduce the rotational motion and or power passing through the hybrid sources 200 and the main power source 205. From the gearbox 220, power may be in communication with a hydraulic pump/motor 225. In times of excess power, the hydraulic pump/motor 225 may operate to fill the hydraulic accumulator 230 with fluid under pressure. In some embodiments, the hydraulic pump/motor 225 is electric and is in communication with the electrical system of the device 100 including the electrical storage device 250. In other embodiments, the hydraulic pump/motor 225 is mechanically driven and is in mechanical communication with the gearbox 220. And in yet an additional embodiment, both mechanical and electric hydraulic pump/motors 225 may be used and managed as circumstances merit.

The gearbox 215 may also be in communication with an additional mechanical continuously variable transmission 235 which may be in communication with a kinetic storage device 500 such as a flywheel 240. In times of excess power, the mechanical continuously variable transmission 235 may communicate power to the kinetic storage device 500 which may spin an object 240, thereby storing the energy.

The gearbox 220 may also be in communication with an integrated starter/generator 245. The integrated starter/generator 245 may operate as a starter and a motor, adding power to the main power unit 205 when needed. The power for the integrated starter/generator 245 may come from an electrical storage device 250 such as a battery or capacitor. In addition, electrical accessories 255 may operate by drawing on the electrical storage device 250. In times when there is excess power, the integrated starter/generator 245 may spin and generate electricity which may be stored in the electronic storage device 250.

Logically, the main power source 205 may be in communication with the gearbox 220 which may provide power to the differential 265 and a planetary gear 260 which may then power the device 100. In yet another aspect, when the main power source 205 is operating as a desired speed but the device 100 does not require all the power, the excess power may be diverted to the hybrid power sources 200 to be stored for future use.

Assist Mode

FIG. 9 may illustrate an assist mode. At a high level, the planetary gears 260 may require more power than the engine 205 is capable of providing at the current time. The hybrid devices 200 may work in concert with the engine 205 to provide the necessary power to the planetary gear 260. The accumulator 230 may release hydraulic fluid that is being held under pressure which may cause the hydraulic motor 225 to spin and provide power to the gearbox 220 which may then pass the power though the differential 265 to the planetary gear 260. In addition, the power stored in the kinetic storage object 240 may be communicated to the additional continuously variable transmission 235 which may provide the power to the differential 265 and then to the planetary gear 260. Further, the battery 250 may provide stored electricity to the integrated starter/generator 245 which provide power to the gearbox 220 which may communicate the power through the gearbox 220 to the differential 265 and then to the planetary gears 260. Each of the hybrid sources 200 may work alone or may work in concert to provide the additional necessary power. The logic in determining which hybrid source 200 to use may be based on a variety of factors and will be discussed further in this application in reference to FIG. 13.

Creep Mode

FIG. 10 may illustrate a mode in which the device 100 may be idle or slowly creeping, making power from the primary source 205 unnecessary. Thus, no power may flow to or from the engine 205. If fact, the engine 205 may be shut down to conserve fuel and eliminate combustion and noise emissions, as well as reduce wear on the engine. The clutch 215 may be disengaged to ensure that power from the hybrid systems 200 is not transmitted to the engine 215. Instead, the accumulator 230 may release hydraulic fluid that is being held under pressure which may cause the hydraulic motor 225 to spin and provide power to the gearbox 220 which may then pass the power though the differential 265 to the planetary gear 260. In addition, the power stored in the kinetic storage object 240 may be communicated to the additional continuously variable transmission 235 which may provide the power to the differential 265 and then to the planetary gear 260. Further, the battery 250 may provide stored electricity to the integrated starter/generator 245 which provide power to the gearbox 220 which may communicate the power through the gearbox 220 to the differential 265 and then to the planetary gears 260. Each of the hybrid sources 200 may work alone or may work in concert to provide the additional necessary power. The logic in determining which hybrid source 200 to use may be based on a variety of factors and will be discussed further in this application in reference to FIG. 13.

Braking Mode

FIG. 11 may describe a braking mode such as when the device 100 requests braking to slow the device 100. The hybrid power sources 200 may be engaged and may be used to absorb the excess energy. The hybrid systems 200 may serve the braking power until the point the hybrid system reach capacity and then conventional braking may be applied in unison. In FIG. 11, the excess power is transferred through the planetary gears 260 to the differential 265. From the differential 265, the power may flow to the additional continuously variable transmission 235 which may provide power to the kinetic storage object 240 (shown as a kinetic power source unit 500 in FIG. 5). In addition, power may flow through the differential 265 to the gear box 220 where power may be provided to the hydraulic pump/motor 225 which may pump hydraulic fluid to the hydraulic accumulator 230 which may store the fluid under pressure. The gearbox 220 may also provide power to an integrated starter/generator 245 which may cause the rotor to spin which may generate electricity which may be stored in a storage device 250 such as a battery or capacitor. The power may also be communicated to the clutch 215 and to the engine 205 which may also provide a resisting force to the planetary gears 260.

Starting Mode

FIG. 12 may illustrate a starting mode. Logically, a battery 250 and other power storing accessory may provide power to an integrated starter/generator 245 which may spin a rotor. The rotor may be in communication with the clutch 215 which may make the engine 205 spin and hopefully start. In addition, the hydraulic accumulator 230 may provide force to the hydraulic motor 225 which may spin and communicate power to the gearbox 220. The gearbox 220 may be in communication with the clutch 215 which may make the engine 205 spin and start. In some embodiments (not shown), if the flywheel 240 has sufficient stored energy, the stored energy also may be tapped to provide a rotational force to the engine 205 to start the engine.

Hybrid Decision Making

FIG. 13 may illustrate at a high level one possible embodiment of deciding which hybrid power source 200 to use. At block 1300, the state of charge of each hybrid system may be determined. For example, the charge in the electric storage device 250 may be determined. In addition, the power path efficiency 1310 of each hybrid system may also be determined. For example, a certain integrated starter/generator may be especially useful at providing a quick burst of torque, making it useful when torque is desired. Similarly, certain hydraulic motors may be less efficient at providing torque making them less efficient when torque is desired.

In block 1320, the state of charge and the power path efficiency of each hybrid system may be scored. The scoring may involve subjecting the state of charge to a charge function and the power path efficiency to a path function and the results of the function may be totaled. The charge function and path function may vary based on a variety of factors, such as the type of power demanded, the anticipated length of time the power will be demanded, the environmental factors, etc. For example, if the device 100 is working in extreme cold environment, batteries 250 may be more quickly depleted of power and the function may take this issue into account.

At block 1330, the power capability of each hybrid system 200 may be evaluated. For example, if excess power is available, it may be stored in one of the hybrid systems 200 if there is sufficient capacity to store the power. If the hybrid system 200 storage is already full, then it may be physically impossible to store more. Similarly, if a power storage device is currently storing little power, the power storage device in question may be the first choice to receive excess power.

At block 1340, the scores from block 1320 are reviewed. Based on the review, power may be obtained from the hybrid system 200 or may be allocated to be stored by the various hybrid systems 200. In addition, if one hybrid system 200 is “full” or at capacity of stored energy, the excess energy may be supplied to another hybrid storage system 200. Similarly, if energy is needed, the scores from block 1320 may be reviewed to determine a hybrid source 200 to be used for excess power. At a high level, whether storing or releasing power, the hybrid system 200 with the highest power score may be selected first. When considering storing power, a high score results from having a low state of charge but high efficiency and when considering releasing power, a high score may result from having a high state of charge and high efficiency.

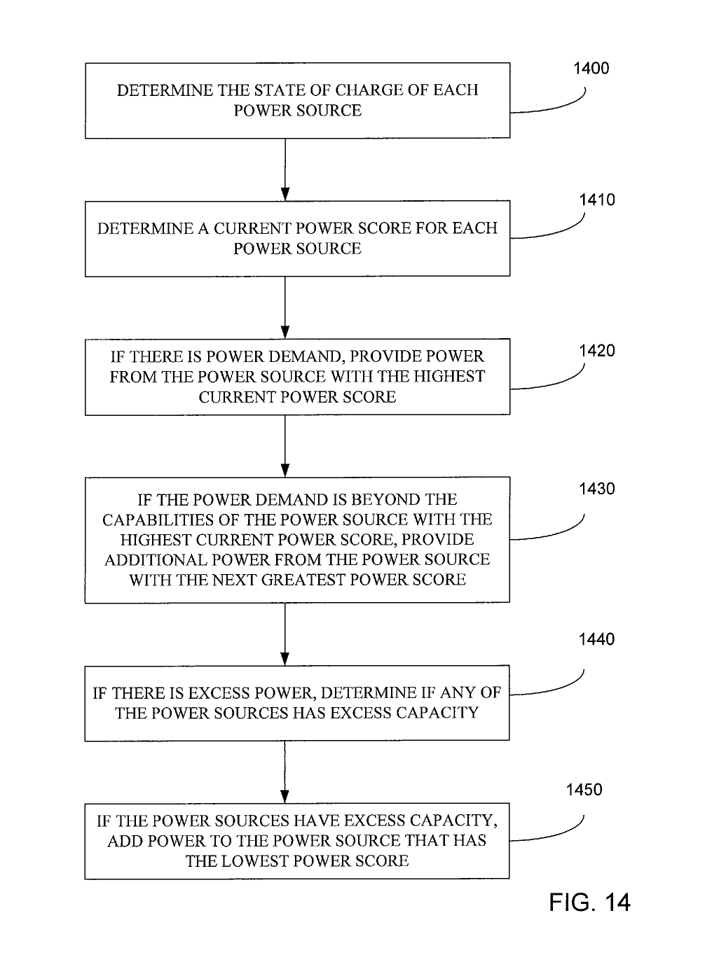

FIG. 14 may illustrate a more detailed decision method for determining which hybrid source 200 to use or to supply with excess power. As illustrated in FIG. 1, there likely will be a main power source 205 such as an internal combustion engine. In some embodiments, the engine 205 may be the primary power source and the hybrid systems 200 may provide additional power to the main power source 205 when necessary and may store addition power when additional power is available. In other embodiments, all the power for the device 100 may come from the various hybrid systems 200. FIG. 19 may illustrate one embodiment of some of the inputs that are evaluated in determining the appropriate mode to execute. More specifically, some examples of possible inputs include but are not limited to a desired torque request 1900, an engine torque limit 1905, a desired engine speed 1910, an actual engine speed 1915, a current gear selection 1920, hybrid system control actual state of charge 1925, the hybrid system control indication of the discharge power currently available 1930 and the hybrid system charge power available 1935. Based on the input, the system may decide to enter into hybrid assist mode 1950, a hybrid regeneration mode 1955, a generation mode 1960, a creep mode 1965, a braking mode 1970 or a starting mode 1975.

At block 1400, the state of charge of each hybrid power source 200 may be determined. Each hybrid power source 200 may store and provide power. At some times, all the hybrid power sources 200 may be fully charged. At other times, all the hybrid power sources 200 may have no charge. Of course, there may be other situations in which some of the hybrid systems 200 are fully charged while other hybrid systems 200 have less of a charge. As mentioned previously, the hybrid sources 200 and storage systems may include a hydraulic source 230, an electric source 250 and a kinetic object 240 but other hybrid sources 200 are possible and are contemplated.

At block 1410, a current power score may be determined for each hybrid power source 200. The power score may be a function of the current state of charge and state of efficiency of each of the hybrid power sources 200. The efficiency may relate to the power in demand and the ability to deliver power from the hybrid device 200. For example, if the demand is for hydraulic power, the power stored in the hybrid accumulator 230 may be more readily available than power stored in batteries 250 that would have to be transmitted to the hydraulic pump/motor 225.

In some situations, it may make sense to use the current hybrid power source 200 until the current hybrid power source 200 falls below a minimum power level. As switching hybrid power sources 200 may take time and power loss, the hybrid power source 200 that is currently providing additional power may continue to provide additional power even if the current power source has less excess power than some of the other hybrid power sources 200. In some embodiments, the function for the current power source may give an additional weight making it more likely the present hybrid source 200 in use will continue to be used. Similarly, if excess power is currently being sent to a first hybrid storage device 200, it may be easier to continue to send power to that hybrid storage device 200. As such, the current storage device 200 may be given an additional weight making it more likely that power will continue to be stored in the same device 200.

At block 1420, if there is power demand, power may be provided from the hybrid power source 200 with the highest current power score. As mentioned previously, the scores may be determined by a function. A simple function may be to simply compare the stored power against the maximum stored power and the score may reflect the amount of empty space in the hybrid storage device 200 as a percentage. If power is needed, the hybrid source 200 with the highest percentage may be used and if power is to be stored, the source with the lowest percentage may be used.

Of course, the function may be more complex. For example, the function may take into account a variety of factors. As previously mentioned, the type of power demanded or excess power to be stored may result in the function weighting toward a particular hybrid storage device 200 over another. Similarly, some hybrid devices 200 may be better at providing instantaneous power than other hybrid devices 200 and if the power demanded is instantaneous power, then an increased weight may be placed on the functions for the hybrid devices 200 that are most capable of providing instantaneous power.

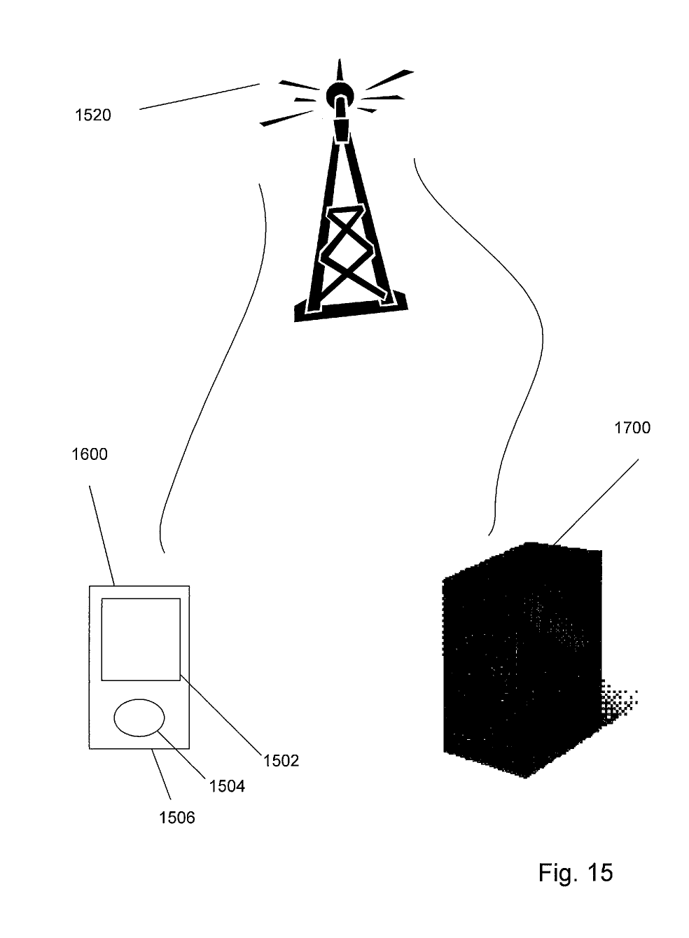

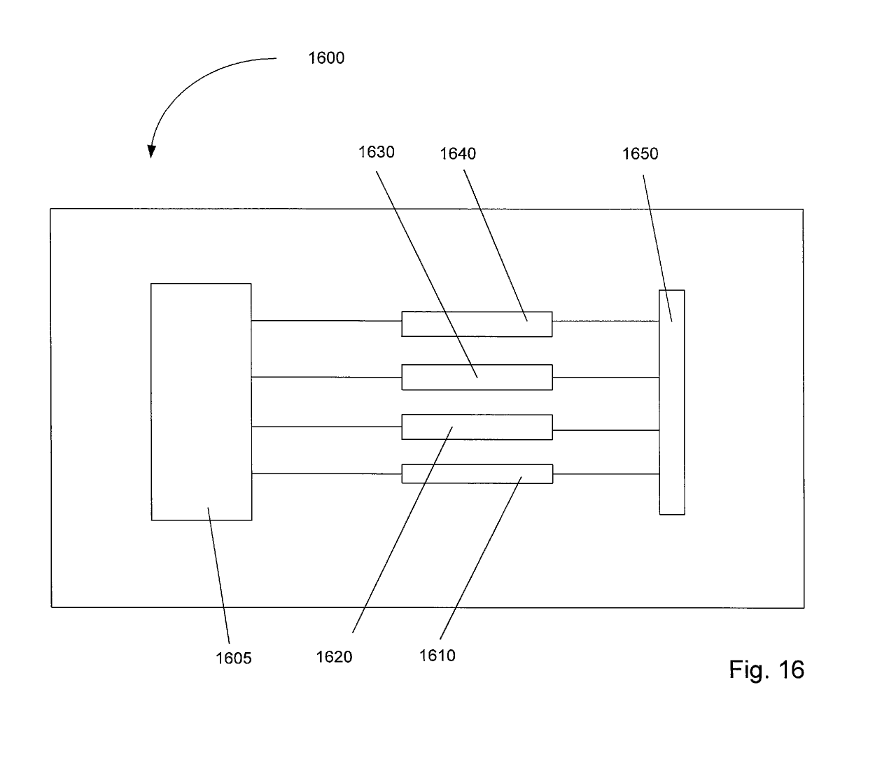

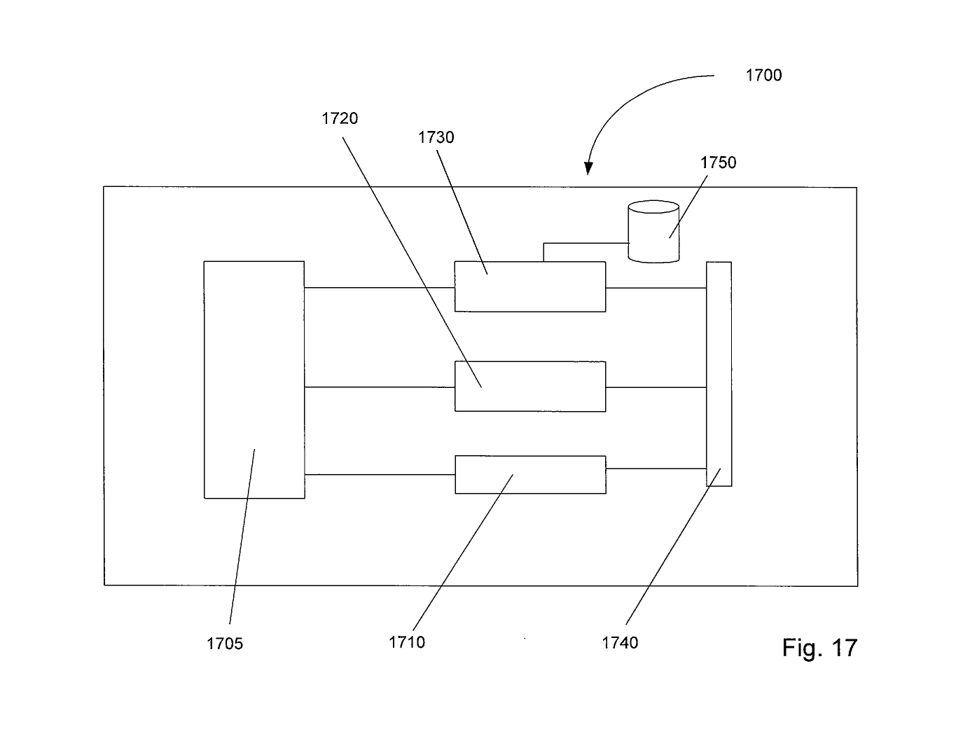

Further, a processor with a memory and an input/output may control and keep track of the decisions of the hybrid power system. To provide ever improving performance, the system may learn from past instances of needing power or storing power and may follow successful outcomes from the past. FIG. 15 may illustrate how the elements of the system may work together, FIG. 16 may illustrate a sample portable computing device, and FIG. 17 may illustrate a sample server.

At block 1430, if the power demand is beyond the capabilities of the hybrid power source 200 with the highest current power score, additional power may be provided from the hybrid power source 200 with the next greater power score. In this embodiment, power from two or more hybrid sources 200 may be used to add power to the main power source 205. In some embodiments, the plurality of hybrid sources 200 may act in concert and in other embodiments, the first hybrid source 200 may operate until it is at a state of exhaustion and then the second hybrid source 200 may assist until it is at a state of exhaustion, etc.

At block 1440, if there is excess power, it may be determined if any of the hybrid powers sources 200 has excess capacity. For example, some of the hybrid sources 200 may not be fully charged and the excess power may be used to charge one or more of the hybrid sources 200. If none of the hybrid sources 200 has excess capacity, then no effort may be made to store the excess power.

At block 1450, if any of the hybrid power sources 200 have excess capacity, power may be added to the hybrid power sources 200. The decision of which hybrid power source 200 to add power may be based on a variety of factors. In one embodiment, the hybrid power source 200 that has the lowest power score may be charged first, the hybrid power source 200 that has the next lowest score may be charged next, etc. In some embodiments, multiple hybrid sources 200 may be charged at the same time. In other embodiments, a first hybrid source 200 may be charged, a second hybrid source 200 may be charged, etc.

Computing Elements

FIG. 15 may be a high level illustration of some of the elements a sample computing system that may be physically configured to execute many of the decisions, including the decisions of the hybrid power system. The computing system may be a dedicated portable computing device 1600 (FIG. 16), a dedicated computing device 1700 (FIG. 17), an application on the computing device that physically configures the processor in the computing device 1700, an application on the portable computing device that configures the processor in the portable computing device 1600 or a combination of all of these elements.

Referring again to FIG. 15, in one embodiment, a portable computing device 1600 may be a device that operates using a portable power source such as a dedicated battery or it may use the battery 250 (FIG. 1) from the device 100. The portable computing device 1600 may also have a display 1602 which may or may not be a touch sensitive display. More specifically, the display 1602 may have a capacitance sensor, for example, that may be used to provide input data to the portable computing device 1600. In other embodiments, an input pad 1640 such as arrows, scroll wheels, keyboards, etc., may be used to provide inputs to the portable computing device 1600. In addition, the portable computing device 1600 may have a microphone 1606 which may accept and store verbal data.

The portable computing device 1600 may be able to communicate with a remote computing device 1700. The portable computing device 1600 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 1700 or may be through a communication network 1620 such as cellular service, through the Internet, through a private network, through Bluetooth, etc.

FIG. 16 may be a simplified illustration of the physical elements that make up a portable computing device 1600 and that may be physically configured according to be part of the system. The portable computing device may be integrated into the device 100 or may be a separate device that is used in or near the device 100. The portable computing device 1600 may have a processor 1605 that is physically configured according to computer executable instructions. It may have a portable power supply 1610 such as a battery which may be rechargeable. It may also use an additional battery, such as the battery 250 in the device 1600. It may also have a sound and video module 1620 which assists in displaying video and sound and may turn off when not in use to conserve power and battery life. The portable computing device 1600 may also have volatile memory 1630 and non-volatile memory 1640. There also may be an input/output bus 1650 that shuttles data to and from the various user input devices such as the microphone 1602, the inputs, etc. It also may control of communicating with the networks, either through wireless or wired devices. Of course, this is just one embodiment of the portable computing device 1600 and the number and types of portable computing devices 1600 is limited only by the imagination.

FIG. 17 may be a sample server 1700 that is physically configured according to be part of the system. The server 1700 may have a processor 1705 that is physically configured according to computer executable instructions. It may have a sound and video module 1710 which assists in displaying video and sound and may turn off when not in use to conserve power and battery life. The server 1700 may also have volatile memory 1720 and non-volatile memory 1730. The database 1750 may be stored in the memory 1720 or 1730 or may be separate. The database 1750 may be part of a cloud of computing device 1700 and may be stored in a distributed manner across a plurality of computing devices 1700. There may be an input/output bus 1740 that shuttles data to and from the various user input devices such as the microphone, the inputs 1702, etc. The input/output bus 1740 also may control of communicating with the networks, either through wireless or wired devices. Of course, this is just one embodiment of the server 1700 and the number and types of portable computing devices 1700 is limited only by the imagination.

User Display of System Status

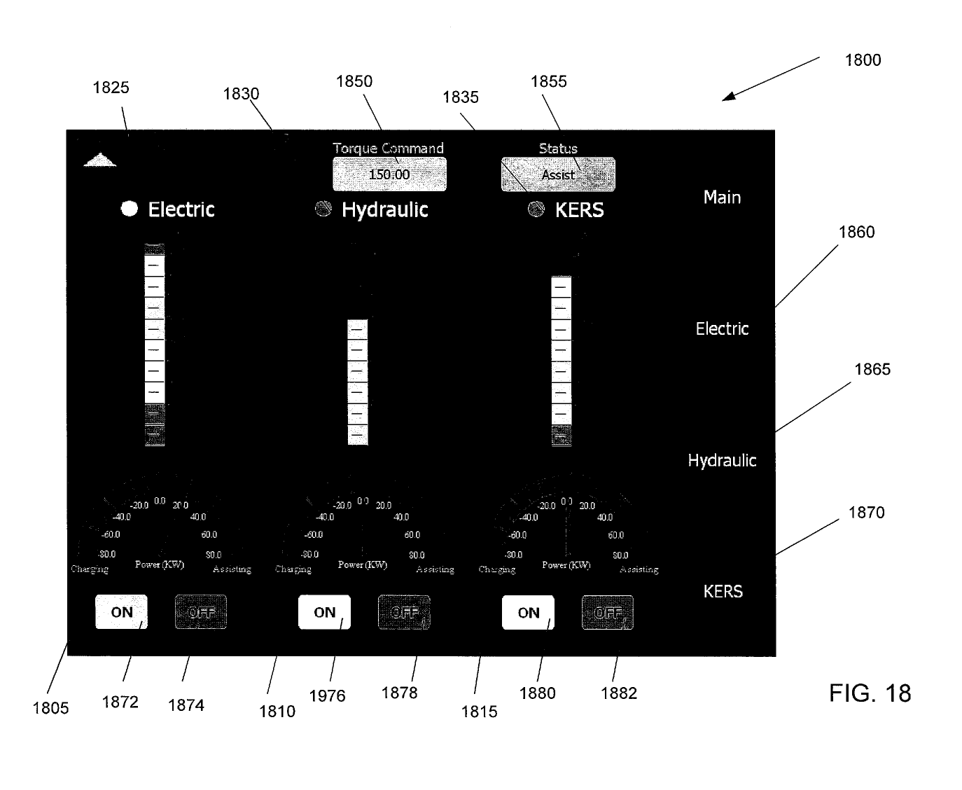

FIG. 18 may illustrate a sample display 1800 that be presented in the device 100 related to the hybrid system. The display 1800 may be on the mobile device 1600, may be a stand-alone display in communication with the mobile device 1600 or another computing device 1700. There may be a plurality of indications that represent the charging status of the various hybrid systems 200. For example in FIG. 18, there may be a dial 1805 that represent whether the electric hybrid system 500 is currently charging or assisting the primary power source 205, another dial 1810 that represents whether the hydraulic hybrid power system 230 is charging or assisting the primary power sources 205 and another dial 1815 that represents whether the kinetic power source 500 is charging or assisting the primary power source 205. Further, there may illustrations of the current power state of each hybrid source 200 such as current charging state of the electric hybrid system 1825, the current charging state of the hybrid hydraulic system 1830 and the current state of charge of the kinetic charging system 1835.

The display 1800 may also display the current status of the system, such as the torque currently demanded 1850 and the current status 1855 such as assisting, charging, resting etc. In addition, indications may be displayed to obtain even more information about the electric hybrid system 1860, the hydraulic system 1865 and the kinetic storage system 1870. An option may be presented to a user to turn on 1872 and off 1874 the hybrid electric system, turn on 1876 or off 1878 the hybrid hydraulic system or turn on 1880 or off 1882 the hybrid kinetic storage system.

The display may display additional information or less information depending on the current state of the device 100 and the hybrid systems 200. In addition, a user may be able to modify the display as desired, such as including some indications and eliminating others or placing the indications on screens that are down in further levels.

FIG. 19 may illustrate the inputs that flow into the system to be evaluated in deciding how the hybrid system should operate and be displayed on the display of FIG. 18. More specifically, some examples of possible inputs include but are not limited to a desired torque request 1900, an engine torque limit 1905, a desired engine speed 1910, an actual engine speed 1915, a current gear selection 1920, hybrid system control actual state of charge 1925, the hybrid system control indication of the discharge power currently available 1930 and the hybrid system charge power available 1935. Based on the input, the system may decide to enter into hybrid assist mode 1950, a hybrid regeneration mode 1955, a generation mode 1960, a creep mode 1965, a braking mode 1970 or a starting mode 1975. In some embodiments, all these inputs may be displayed on the display such as described in FIG. 18. In other embodiments, the input readings may be available through selecting to see additional menus.

Additional Considerations for the Hybrid Systems

In some embodiments, the function used to score the hybrid power sources 200 may take into account the type of energy that is available to be stored. For example, if the device 100 is traveling downhill, energy may be stored in the kinetic source 500 as the energy may be easily transferred to the kinetic source 500. In such a case, the function may be modified to add additional weight to direct the excess energy toward the most logical hybrid storage source 200. Similarly, in other designs, the downhill force may be easily converted into electricity that may be easily stored in the electric storage devices 250. In such a case, the function may be modified to add additional weight to direct the excess energy toward the most logical storage source 200. As yet another example, if the excess power is hydraulic pressure, it may be most logical to store the hydraulic pressure in the hydraulic accumulator 230. In such an embodiment, the function may be modified to add additional weight to direct the excess energy toward the most logical storage source, specifically, the hydraulic accumulator 230.

The excess energy may also exist when the main power source 205 is not operating at a full load. The excess power that is not being used but the current power load may be used to add power to the hybrid power sources 200. For example, an engine may operate at 2,000 rpm and a given amount of power may be available from the engine at 2,000 rpm without taxing the engine 205. One or more hybrid systems 200 may tap into the excess power and from the engine 205 to provide power to one or more of the hybrid system 200 to be stored.

Further, a processor with a memory and an input/output may control and keep track of the decisions of the hybrid power system. Thus, the system may learn from past instances of storing excess power and may follow successful outcomes from the past. The system may continually learn and improve the scoring functions and decision making process. For example, the system may track in a memory past inputs to the system in a manner which allows the inputs to be searched and analyzed. Some possible inputs include the time of day, the length of operations, the source of the power demand, the current functions demand power, the previous functions demanding power, etc.

The inputs may be stored locally such as on the portable computing device 1600 or remotely such as on the server 1700. As an example, the inputs may be stored in a cloud storage system making the inputs and analysis available to all machines operating. In yet another embodiment, all the data is forwarded to a central analysis site where the data is analyze and continual improvements are made to the functions based on the inputs. Further, the data may be analyzed for errors and maintenance reminders that may need attention on the device 100 in question or across multiple devices.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A method of controlling power in a hybrid power system comprising a plurality of power sources comprising:
Determining the state of charge of each power source wherein the power source stores and provides power;
Determining a current power score for each power source wherein the power score comprises a function of the current state of charge and state of efficiency;
If there is power demand, providing power from the power source with the highest current power score;
If the power demand is beyond the capabilities of the power source with the highest current power score, providing additional power from the power source with the next greater power score;
If there is excess power, determining if any of the powers sources has excess capacity; and
If the power sources have excess capacity, adding power to the power source that has the lowest power score.

2. The method of claim 1, wherein the power sources comprises a hydraulic source, an electric source and a kinetic source.

3. The method of claim 1, wherein the kinetic source comprises a flywheel.

4. The method of claim 1, wherein the electric source comprises at least one of a capacitor and a battery.

5. The method of claim 1, wherein the hydraulic source comprises a hydraulic reservoir and a hydraulic pump.

6. The method of claim 1, further comprising using the current power source until the current power source falls below a minimum power level.

7. The method of claim 1, further comprising an internal combustion engine as a primary power source which communicates with the plurality of power sources.

8. The method of claim 1, further comprising storing energy in the kinetic source when the device is traveling downhill or when braking is requested.

9. The method of claim 1, further comprising storing energy in the hydraulic source when there is excess hydraulic pressure.

10. The method of claim 1, further comprising storing energy in the electric source when the engine is not operating under a load maximum.

11. A method of controlling power in a motorized work device with an internal combustion power system and a hybrid power system comprising a plurality of power sources comprising:
Determining the state of charge of each hybrid power source wherein the power source stores and provides power;
Determining a current power score for each hybrid power source wherein the power score comprises a function of the current state of charge and state of efficiency;
If there is power demand, providing power from the hybrid power source with the highest current power score;
If the power demand is beyond the capabilities of the hybrid power source with the highest current power score, providing additional power from the hybrid power source with the next greater power score;
If there is excess power torque from the internal combustion engine, determining if any of the hybrid power sources has excess capacity; and
If the hybrid power sources have excess capacity, adding power to the power source that has the lowest power score.

12. The method of claim 11, wherein the power sources comprises a hydraulic source, an electric source and a kinetic source.

13. The method of claim 11, wherein the kinetic source comprises a flywheel.

14. The method of claim 11, wherein the electric source comprises at least one of a capacitor and a battery.

15. The method of claim 11, wherein the hydraulic source comprises a hydraulic reservoir and a hydraulic pump.

16. The method of claim 11, further comprising using the current power source until the current power source falls below a minimum power level.

17. The method of claim 11, further comprising an internal combustion engine as a primary power source which communicates with the plurality of power sources.

18. The method of claim 11, further comprising storing energy in the kinetic source when the device is traveling downhill or when braking is requested.

19. The method of claim 11, further comprising storing energy in the hydraulic source when there is excess hydraulic pressure.

20. The method of claim 11, further comprising storing energy in the electric source when the engine is not operating under a load maximum.
